(19) United States
(12) Patent Application Publication
(10) Pub. No.: US 2008/0048094 A1
(43) Pub. Date: Feb. 28, 2008

(54) Device for the Mass Production of a Hollow Building Block from a Hydraulically-Hardening Moist Building Block Mass

(76) Inventors: Norbert Kranzinger, Neumarkt (AT); Klaus Dambauer, Salzburg (AT)

Correspondence Address: WILLIAM COLLARD;COLLARD & ROE, P.C., 1077 NORTHERN BOULEVARD, ROSLYN, NY, 11576, US

(21) Appl. No.: 11/630,073

(22) PCT Filed: Jul. 6, 2005
(86) PCT No.: PCT/AT05/00250

§ 371 Date: Dec. 19, 2006

(30) Foreign Application Priority Data
Jul. 8, 2004 (AT) A 1153/2004

(51) Int. Cl. B28B 7/18

(52) U.S. Cl. 249/60

(57) ABSTRACT

A device is described for producing a hollow building block from a hydraulically curing, moist building block compound having a mold open on top (1), which comprises core spikes (4) projecting from a mold floor (2) inside mold walls and positioned with lateral spacing to one another to implement hollow chambers of the hollow building block, and having a filling truck (9) movable along a guide (6) above the mold (1), which forms a receptacle chamber (12), delimited by peripheral walls (13), having a screen floor (14) for delivering the received building block compound. In order to achieve uniform filling of the mold (1), it is suggested that the screen floor (14), which is mounted in the filling truck (9) so it is capable of oscillation, be connected to an oscillation drive (16) and have different-sized screen openings having an opening cross-section which suppresses free passage of the moist building block compound as a result of its intrinsic weight and a distribution over the mold cross-section as a function of the course of the peripheral walls (13) of the receptacle chamber (12) and/or the mold walls and the configuration of the core spikes (4), and the filling truck (9) may be locked in a stop-delimited filling position above the mold (1).

### FIELD OF THE INVENTION

The present invention relates to a device for producing a hollow building block from a hydraulically curing, moist building block compound using a mold open on top, which comprises core spikes, which project inside mold walls from a mold floor and are situated with lateral spacing to one another, to implement hollow chambers of the hollow building block, and having a filling truck movable along a guide above the mold, which forms a receptacle chamber delimited by a peripheral walls having a screen floor for delivering the accommodated building block compound.

### DESCRIPTION OF THE PRIOR ART

Providing a mold having a mold floor, on which a mold box forming the mold walls is placed and through which core spikes engage from below into the mold chamber enclosed by the mold box to implement the hollow chambers, is known (EP 0 706 864 A2) for producing hollow building blocks having multiple hollow chambers from a hydraulically curing building block compound. The mold is filled with the moistened building block compound with the aid of a filling truck movable along a guide above the mold before the building block compound poured into the mold is compacted with the aid of a ram, which has corresponding passage openings for receiving the core spikes projecting from the mold floor. To demold the hollow building block produced in this way, the core spikes are retracted downward from the mold chamber through the mold floor and the mold box is raised from the mold floor.

In order to achieve uniform compaction of the moist building block compound in the mold and thus identical mechanical properties of the hollow building block over its cross-section, filling the form with the moist building block compound uniformly over the cross-section is required, which may not be ensured with the aid of the typical filling truck, however. This is because of the tendency of the moist building block compound to clump and, in addition, because uniform delivery of the building block compound may not be ensured over the cross-section of the floor opening of the filling truck. In addition, the delivery quantity of building block compound is a function of the velocity at which the filling truck is moved over the mold. If the filling truck is provided with a screen floor to break up the delivered building block compound, the irregularities occurring may be reduced, but not avoided.

### SUMMARY OF THE INVENTION

The present invention is thus based on the object of implementing a device for producing a hollow building block of the type described at the beginning in such a way that uniform filling of the mold with moist building block compound, as a requirement for mechanical properties which are uniform over the cross-section of the hollow building block to be produced, may be ensured.

The present invention achieves the stated object in that the screen floor, which is mounted in the filling truck so it is capable of oscillation, is connected to an oscillation drive and has different-sized screen openings having an opening cross-section which suppresses free passage of the moist building block compound as a result of its intrinsic weight in a distribution which is a function of the course of the peripheral walls of the receptacle chamber and/or the mold walls and the configuration of the core spikes over the mold cross-section, and the filling truck may be locked in a stop-delimited filling position above the mold.

The present invention proceeds from the recognition that because of the internal friction of the moist building block compound and the friction between the building block compound and the peripheral walls of the receptacle chamber, uneven delivery conditions result over the screen area. For this reason, the screen floor is provided with different-sized screen openings to equalize these irregularities. However, not only the irregular delivery conditions of the building block compound from the receptacle chamber of the filling truck, but rather also irregular filling conditions in the area of the mold may be taken into consideration by these different-sized screen openings, in that the distribution of the different-sized screen openings over the mold cross-section is selected as a function of the course of the peripheral walls of the receptacle chamber and the mold walls and the configuration of the core spikes of the mold. However, this means that the filling truck must assume a predefined filling position in relation to the mold for the filling of the mold with the building block compound. In addition, the mold may first be filled in the filling position of the filling truck. These requirements are fulfilled by locking the filling truck in the stop-delimited filling position and, in addition, in that the different screen openings have an opening cross-section which suppresses free passage of the moist building block compound as a result of its intrinsic weight. To deliver the moist building block compound, the screen floor is to be subjected to a shaking movement with the aid of an oscillation drive, which ensures the passage of the building block compound through the screen openings. As a result, the screen floor is to be mounted in the filling truck so it is capable of oscillation.

Although different constructions may be used for exciting the oscillation of the screen floor, especially simple constructive conditions result if the screen floor is mounted in a displacement guide of the filling truck and is connected to an eccentric drive as the oscillation drive. In addition, the amplitudes and the oscillation frequencies may be tailored to the particular requirements in regard to the building block compound used via the eccentricity and/or the revolution speed of the eccentric drive.

Because of the excitation of oscillation of the screen floor, the danger of clogging may be largely precluded. Therefore, various screen floors may be used. Especially favorable delivery conditions result, however, if the screen floor comprises a grating. The rods of this grating may additionally have different cross-sections, which opens a further influence possibility on the delivery conditions for the moist building block compound.

### BRIEF DESCRIPTION OF THE DRAWING

An example of the object of the present invention is illustrated in the drawing.

FIG. 1 shows a device according to the present invention for producing a hollow building block in detail in the area of the filling truck located in the filling position in a simplified top view and

FIG. 2 shows this device in a section along line II-II of FIG. 1.

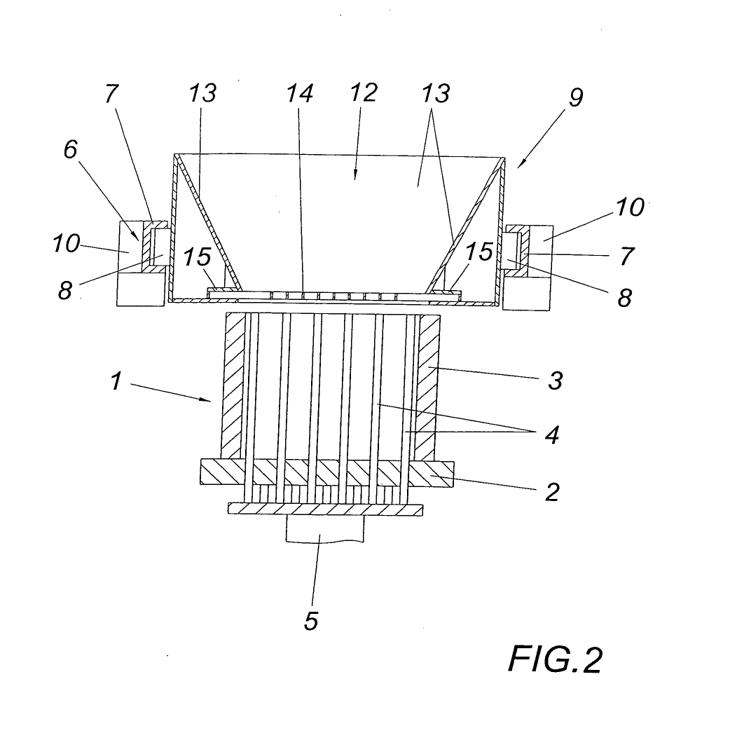

### DESCRIPTION OF THE PREFERRED EMBODIMENT

According to the exemplary embodiment shown, the device for producing a hollow building block has a mold 1 open on top, which comprises a mold floor 2 and a mold box 3 placed on the mold floor 2. Core spikes 4, which penetrate the mold floor 2 and may be drawn out of the mold chamber through the mold floor 2 with the aid of a plunger 5 to demold the hollow building block, are used to implement the hollow chambers of the hollow building block to be manufactured. A guide 6 is provided above the mold 1, which comprises two lateral guide rails 7 for the casters 8 of a filling truck 9. This guide 6 forms stops 10 for a filling position of the filling truck 9 above the mold 1. An actuating drive 11, such as an actuating cylinder, with the aid of which the filling truck 9 may be locked in the stop position, is used to drive the filling truck 9.

The filling truck 9 forms a receptacle chamber 12, which is open on top, for a hydraulically curing, moist building block compound, from which the hollow building block is manufactured. The receptacle chamber 12 is delimited by peripheral walls 13 and a screen floor 14, which is mounted so it is capable of oscillation in a displacement guide 15 of the filling truck 9 and is connected to an oscillation drive 16. This oscillation drive 16 is implemented as an eccentric drive and has an eccentric 18, driven by an electric motor 17, to which a connecting rod 19 engaging on the screen floor 14 is linked. To adjust the amplitude of the oscillation drive 16, the linkage axis 20 for the connecting rod 19 is mounted on the eccentric 18 so it is radially adjustable. Moreover, the oscillation frequencies may be set via the electric motor 17, so that the screen floor 14 may be tailored easily to the particular requirements in regard to the building block compound in regard to its oscillation excitation.

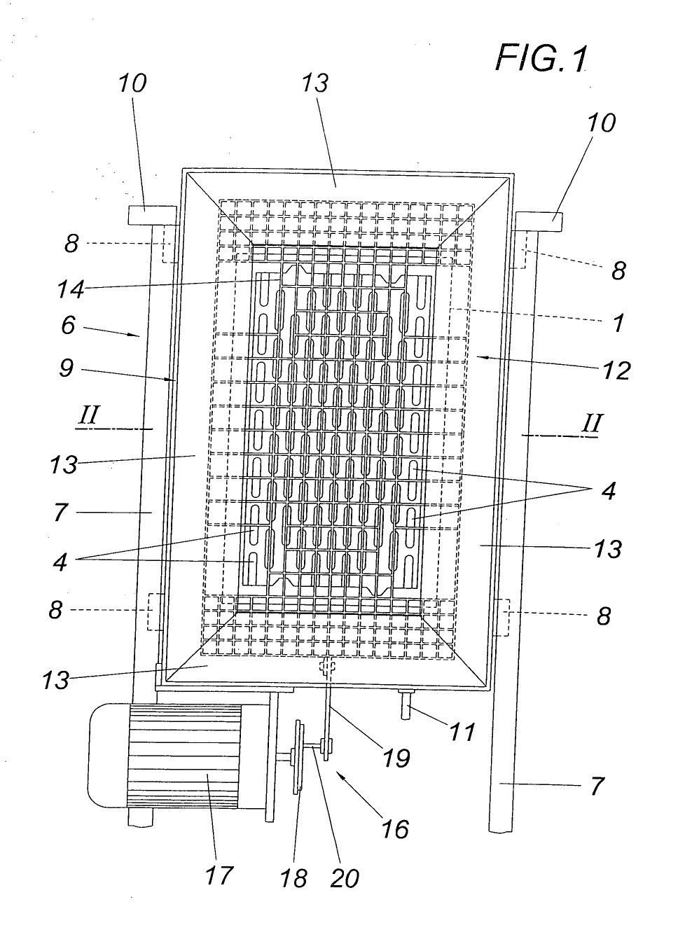

The screen floor 14 is implemented as a grating and has different-sized screen openings between the individual grating rods, as may be seen in particular in FIG. 1. The cross-section of the screen openings is delimited on top, to suppress free passage of the moist building block compound through the screen floor because of its intrinsic weight. It is thus possible to move the filling truck 9 filled with the moist building block compound into the filling position shown in FIG. 1 without delivery of the building block compound. The oscillation drive 16 for the screen floor 14 is first turned on in the locked filling position in order to deliver the building block compound from the receptacle chamber 12 into the mold 1 located below the screen floor 14. Because of the different-sized screen openings, the delivery, which is uneven as a result of the friction between the peripheral walls 13 and the building block compound, is equalized, so that uniform filling of the mold 1 with the moist building block compound may be expected, because the screen floor 14 accordingly has larger screen openings precisely in the area of the peripheral walls 13. Since the distribution of the screen openings may additionally be selected as a function of the course of the mold walls and core spikes 4 of the mold 1, the distribution of the moist building block compound in the mold 1 may be influenced in a way which ensures the desired uniform filling of the mold 1.

1. A device for producing a hollow building block from a hydraulically curing, moist building block compound having a mold open on top, which comprises core spikes projecting from a mold floor inside mold walls and positioned with lateral spacing to one another to implement hollow chambers of the hollow building block, and having a filling truck movable along a guide above the mold, which forms a receptacle chamber, delimited by peripheral walls, having a screen floor for delivering the received building block compound, wherein the screen floor (14), which is mounted in the filling truck (9) so it is capable of oscillation, is connected to an oscillation drive (16) and has different-sized screen openings having an opening cross-section which suppresses free passage of the moist building block compound as a result of its intrinsic weight and a distribution over the mold cross-section as a function of the course of the peripheral walls (13) of the receptable chamber (12) and/or the mold walls and the configuration of the core spikes (4), and the filling truck (9) may be locked in a stop-delimited filling position above the mold (1).

2. The device according to claim 1, wherein the screen floor (14) is mounted in a displacement guide (15) of the filling truck (9) and is connected to an eccentric drive as the oscillation drive (16).

3. The device according to claim 2, wherein the eccentricity and/or the revolution speed of the eccentric drive are adjustable.

4. The device according to claim 1, wherein the screen floor (14) comprises a grating.

5. The device according to claim 4, wherein the rods of the grating have different cross-sections.
